(19) United States
(12) Patent Application Publication
(10) Pub. No.: US 2026/0098111 A1
(43) Pub. Date: Apr. 9, 2026

(54) RUBBER COMPOSITION AND PNEUMATIC TIRE

(71) Applicant: Toyo Tire Corporation, Itami-shi (JP)

(72) Inventor: Manabu Fukushima, Itami-shi (JP)

(73) Assignee: Toyo Tire Corporation, Itami-shi (JP)

(21) Appl. No.: 19/335,135

(22) Filed: Sep. 22, 2025

(30) Foreign Application Priority Data
Oct. 9, 2024 (JP) 2024-177098

(51) Int. Cl. C08F 136/02; B60C 1/00; B60C 11/00; C08K 5/103

(52) U.S. Cl. CPC C08F 136/02; B60C 1/0016; B60C 11/0008; C08K 5/103

(57) ABSTRACT

A rubber composition comprising a diene-based rubber and a vegetable oil, wherein the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more, and at least a modified butadiene rubber is contained as the diene-based rubber. It is preferrable that the vegetable oil has a ratio of a polyunsaturated fatty acid in the unsaturated fatty acid of 15 mass % or more. It is preferrable that a content of the vegetable oil is 5 to 30 parts by mass when a total amount of the diene-based rubber is taken as 100 parts by mass.

### BACKGROUND OF THE INVENTION

### Field of the Invention

The present invention relates to a rubber composition and a pneumatic tire.

### Description of the Related Art

A pneumatic tire is required to have traveling performance in various situations, and in particular, an all-season pneumatic tire is required to have, for example, wet grip performance on a wet road surface and low-temperature performance on a frozen road surface (icy road surface). In addition, due to the recent demand for resource saving, a pneumatic tire is required to have low fuel consumption on any road surface, and thus required to have reduction in rolling resistance (hereinafter, also simply referred to as “rolling performance”) of the pneumatic tire.

Patent Document 1 mentioned below discloses a rubber composition for tire treads, including: a raw material rubber containing 20 to 50 parts by weight of a first styrene-butadiene rubber, 20 to 50 parts by weight of a second styrene-butadiene rubber, and 10 to 40 parts by weight of a butadiene rubber (BR); and 80 to 180 parts by weight of a reinforcing filler, 2 to 50 parts by weight of natural oil, and 2 to 30 parts by weight of a hydrocarbon resin with respect to 100 parts by weight of the raw material rubber.

Patent Document 2 mentioned below discloses a rubber composition for tire treads, including: 100 parts by weight of a raw material rubber, 70 to 120 parts by weight of a reinforcing filler, and 10 to 60 parts by weight of a natural oil with a ratio of linoleic acid:oleic acid of 1:0.5 to 1:5, wherein the raw material rubber includes 5 to 10 parts by weight of a natural rubber, 40 to 70 parts by weight of a solution polymerized styrene-butadiene rubber, and 20 to 50 parts by weight of a neodymium butadiene rubber, the solution polymerized styrene-butadiene rubber has a styrene content of 20 to 50 wt %, a vinyl content of 10 to 40 wt %, a Tg of −50 to −20° C., and 20 to 40 parts by weight of SRAE oil, the reinforcing filler includes 65 to 100 parts by weight of silica and 5 to 20 parts by weight of carbon black, and the silica has a nitrogen adsorption value of 160 to 180 m²/g, a CTAB adsorption value of 150 to 170 m²/g, and a DBP oil absorption amount of 180 to 200 cc/100 g.

Patent Document 3 mentioned below discloses a cross-linkable or cross-linked rubber composition usable for constituting a tire tread, the composition being based on at least: one or more diene elastomers including 50 phr to 100 phr of a majority diene elastomer selected from the group consisting of styrene-butadiene copolymers prepared in solution, styrene-butadiene copolymers prepared in emulsion, natural polyisoprenes, synthetic polyisoprenes having a cis-1,4 linkage content greater than 95%, and mixtures of these elastomers and 0 phr to 50 phr of a minority diene elastomer being a polybutadiene having a cis-1,4 linkage content greater than 90%; and a plasticizer including a vegetable oil containing at least one glycerol oleic acid triester, wherein the plasticizer includes in a mass fraction of 45% to 100%, as the vegetable oil, a sunflower oil the oleic acid of which represents a mass fraction equal to or greater than 70% of the entire fatty acid, and in a mass fraction of 55% to 0%, one or more plasticizing oils extracted from petroleum, of paraffinic, aromatic, or naphthenic type, the amount of sunflower oil lies within a range of 10 to 40 phr, and the amount of optional plasticizing oil extracted from petroleum lies within a range of 0 to 30 phr.

### PRIOR ART DOCUMENTS

### Patent Documents

Patent Document 1: JP-A-2019-172957
Patent Document 2: JP-B2-6522716
Patent Document 3: JP-B2-4209200

### SUMMARY OF THE INVENTION

As a result of intensive studies by the present inventor, it has been found that it is difficult to solve three problems of wet grip performance, low-temperature performance, and rolling performance in a balanced way by the techniques described in Patent Documents 1 to 3.

In light of such circumstances, it is an object of the present invention to provide a rubber composition for use as a raw material of a vulcanized rubber for tires with wet grip performance, low-temperature performance, and reduction in rolling resistance improved in a balanced way, and a pneumatic tire including a vulcanized rubber of the rubber composition.

The above object can be achieved by the following configurations. Specifically, the present invention relates to a rubber composition (1) containing a diene-based rubber and a vegetable oil, wherein the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more, and at least a modified butadiene rubber is contained as the diene-based rubber.

The rubber composition (1) is preferably a rubber composition (2), wherein the vegetable oil preferably has a ratio of a polyunsaturated fatty acid in the unsaturated fatty acid of 15 mass % or more.

The rubber composition (1) or (2) is preferably a rubber composition (3), wherein a content of the vegetable oil is 5 to 30 parts by mass when a total amount of the diene-based rubber is taken as 100 parts by mass.

Any one of the rubber compositions (1) to (3) is preferably a rubber composition (4), wherein a content of the modified butadiene rubber is 20 to 80 parts by mass when a total amount of the diene-based rubber is taken as 100 parts by mass.

Any one of the rubber compositions (1) to (4) is preferably a rubber composition (5), further including silica, wherein a content of the silica is 80 to 180 parts by mass when a total amount of the diene-based rubber is taken as 100 parts by mass.

The present invention also relates to a pneumatic tire (6) including at least a vulcanized rubber of any one of the rubber compositions (1) to (5), particularly to a pneumatic tire (7) including a vulcanized rubber of any one of the rubber compositions (1) to (5) at least on a surface of a tread part.

The rubber composition according to the present invention contains at least a modified butadiene rubber and a vegetable oil having a specific unsaturated fatty acid ratio. More specifically, the rubber composition according to the present invention contains, in a diene-based rubber containing at least a modified butadiene rubber, a vegetable oil which is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more. The vulcanized rubber of the rubber composition having such a configuration can achieve wet grip performance, low-temperature performance, and rolling performance improved in a balanced way. In particular, when the rubber composition according to the present invention further contains a high content of silica, the reinforcing effect of silica is more effectively exhibited by the dispersion effect of silica by a specific vegetable oil and the interaction with silica by a modified butadiene rubber. As a result, a vulcanized rubber to be finally obtained can achieve wet grip performance, low-temperature performance, and rolling performance improved in a more balanced way.

The vulcanized rubber of the rubber composition according to the present invention achieves wet grip performance, low-temperature performance, and rolling performance improved in a balanced way. Therefore, the vulcanized rubber of the rubber composition according to the present invention can be suitably used for pneumatic tires, and is particularly useful as a vulcanized rubber used for a surface portion of a tread part called a cap tread in tread applications of pneumatic tires.

### DETAILED DESCRIPTION OF THE PREFERRED EMBODIMENTS

The rubber composition according to the present invention contains a diene-based rubber and a vegetable oil.

The rubber composition according to the present invention contains at least a modified butadiene rubber as the diene-based rubber. The modified butadiene rubber contains functional group(s) that contain heteroatom(s). While functional group(s) that contain heteroatom(s) may be introduced at end(s) of polymer chain(s) or in mid-chain, it is preferred that they be introduced at end(s) thereof. As functional group(s) that contain heteroatom(s), amino groups, alkoxyl groups, hydroxyl groups, epoxy groups, carboxyl groups, cyano groups, halogen atoms, tin functional groups, and so forth may be cited as examples. As amino group(s), primary amino groups, secondary amino groups, tertiary amino groups, and so forth may be cited as examples. As alkoxyl group(s), methoxy groups, ethoxy groups, propoxy groups, butoxy groups, and so forth may be cited as examples. As the halogen group(s), chlorine, bromine, and so forth may be cited as examples. The functional groups that were cited as examples interact with various functional groups of fillers, particularly carbon black, and silanol groups (Si—OH) of silica. Here, “interaction” means, for example, in the case of silica, that there is formation of a hydrogen bond or a chemical bond caused by chemical reaction with a silanol group of silica.

In order to improve wet grip performance, low-temperature performance, and rolling performance of the vulcanized rubber in a balanced way, a content of the modified butadiene rubber is preferably 20 to 80 parts by mass and more preferably 30 to 60 parts by mass when the total amount of the diene-based rubber in the rubber composition is taken as 100 parts by mass.

The rubber composition according to the present invention may contain a diene-based rubber other than the modified butadiene rubber. Examples of the diene-based rubber include, but are not limited to, natural rubber (NR), isoprene rubber (IR), butadiene rubber (BR) having no modifying group (functional group), styrene-butadiene rubber (SBR), acrylonitrile-butadiene rubber (NBR), chloroprene rubber (CR), styrene-isoprene copolymer rubber, butadiene-isoprene copolymer rubber, and styrene-isoprene-butadiene copolymer rubber. These diene-based rubbers may be used singly or in combination of two or more of them.

The rubber composition according to the present invention contains a specific vegetable oil, specifically, a vegetable oil which is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more. In the present invention, the vegetable oil is represented by the following formula (1).

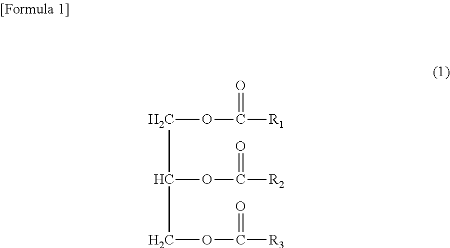

In the above formula (1), R₁, R₂, and R₃ are residues of a fatty acid of either a saturated fatty acid or an unsaturated fatty acid. Examples of the saturated fatty acid include palmitic acid (C16:0) and stearic acid (C18:0). Examples of the unsaturated fatty acid include oleic acid (C18:1), linoleic acid (C18:2), and linolenic acid (C18:3). The rubber composition according to the present invention contains a fatty acid ester triglyceride (vegetable oil) having a ratio of the unsaturated fatty acid in the fatty acid of 50 mass % or more. In order to improve wet grip performance, low-temperature performance, and rolling performance of the vulcanized rubber in a more balanced way, it is preferable to use a fatty acid ester triglyceride having a ratio of the unsaturated fatty acid in the fatty acid of 50 mass % or more, and it is more preferable to use a fatty acid ester triglyceride having a ratio of 70 mass % or more.

From the viewpoint of solving the problems, in the rubber composition according to the present invention, a content of the fatty acid ester triglyceride (vegetable oil) is preferably 5 to 30 parts by mass and more preferably 10 to 25 parts by mass when the total amount of the diene-based rubber is taken as 100 parts by mass.

Among fatty acid ester triglycerides (vegetable oils), fatty acid ester triglycerides (vegetable oils) having a high ratio of linoleic acid or linolenic acid as a polyunsaturated fatty acid (hereinafter, also referred to as “PUFA”) having two or more unsaturated bonds are preferable because the wet grip performance, low-temperature performance, and rolling performance of a vulcanized rubber to be finally obtained can be improved in a particularly balanced way. Particularly, in the present invention, from the viewpoint of solving the problems, it is preferable to use a fatty acid ester triglyceride (vegetable oil) having a ratio of the polyunsaturated fatty acid (PUFA) in the unsaturated fatty acid of 15 mass % or more, it is preferable to use a fatty acid ester triglyceride having a ratio of 20 mass % or more, and it is more preferable to use a fatty acid ester triglyceride having a ratio of 70 mass % or more.

In the present invention, rapeseed oil, soybean oil, safflower oil, and sunflower oil can be suitably used as the fatty acid ester triglyceride (vegetable oil). Table 1 shows the fatty acid composition of each vegetable oil.

TABLE 1

| | Saturated fatty acid (%) | | Unsaturated fatty acid (%) | | | | |
|---|---|---|---|---|---|---|---|
| | SAFA | SAFA | MUFA | PUFA | PUFA | Fatty acid parameter | |
| | Number of | Number of | Number of | Number of | Number of | Unsaturated | |
| | carbons:Number | carbons:Number | carbons:Number | carbons:Number | carbons:Number | fatty acid | PUFA |
| Type of | of double | of double | of double | of double | of double | ratio in | ratio in |
| vegetable | bonds 16:0 | bonds 18:0 | bonds 18:1 | bonds 18:2 | bonds 18:3 | total fatty | unsaturated |
| oil | Palmitic acid | Stearic acid | Oleic acid | Linoleic acid | α-Linolenic acid | acids | fatty acid |
| Rapeseed oil | 4.1 | 1.7 | 63.5 | 19.3 | 9 | 91.8 | 30.8 |
| Soybean oil | 10.6 | 4.1 | 23.3 | 53.7 | 7.2 | 84.2 | 72.3 |
| Safflower oil | 4.9 | 2.1 | 78.3 | 13.3 | 0.3 | 91.9 | 14.8 |
| Sunflower oil | 4 | 2.7 | 82.7 | 8.5 | 0.2 | 91.4 | 9.5 |
| Palm oil | 44 | 4.5 | 39.7 | 9.6 | 0.2 | 49.5 | 19.8 |

As shown in Table 1, rapeseed oil (having a ratio of the polyunsaturated fatty acid (PUFA) in the unsaturated fatty acid of 30.8 mass %) and soybean oil (having a ratio of the polyunsaturated fatty acid (PUFA) in the unsaturated fatty acid of 72.3 mass %) have a high PUFA ratio. Therefore, when the rubber composition according to the present invention contains rapeseed oil or soybean oil as fatty acid ester triglyceride (vegetable oil), the wet grip performance, low-temperature performance, and rolling performance of a vulcanized rubber to be finally obtained can be improved in a particularly balanced way, which is preferable.

Among fatty acid ester triglycerides (vegetable oils), in particular, when a fatty acid ester triglyceride having an iodine value of 100 or more is used, the amount of double bonds in the fatty acid ester triglyceride (vegetable oil) is increased, and therefore the wet grip performance, low-temperature performance, and rolling performance of a vulcanized rubber to be finally obtained can be improved in a particularly balanced way, which is preferable.

When the rubber composition according to the present invention contains silica as a filler and further contains silica in a high content, the reinforcing effect of silica is more effectively exhibited by the dispersion effect of silica by a specific vegetable oil and the interaction with silica by a modified butadiene rubber. As a result, a vulcanized rubber to be finally obtained can achieve wet grip performance, low-temperature performance, and rolling performance improved in a more balanced way. Examples of the silica to be used include silicas usually used for rubber reinforcement, such as wet silica, dry silica, sol-gel silica, and surface-treated silica. Among these, wet silica is preferred. From the viewpoint of solving the problems, in the rubber composition according to the present invention, a content of silica is preferably 80 to 180 parts by mass and more preferably 100 to 150 parts by mass when the total amount of the diene-based rubber is taken as 100 parts by mass. Particularly, in the present invention, when a modified butadiene rubber, a high content of silica, and rapeseed oil or soybean oil having a high ratio of the polyunsaturated fatty acid (PUFA) in the unsaturated fatty acid are used in combination, a vulcanized rubber to be finally obtained can achieve wet grip performance, low-temperature performance, and rolling performance improved in a more balanced way, which is preferable.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl) tetrasulfide (e.g., “Si69” manufactured by Evonik Japan Co., Ltd.), bis(3-triethoxysilylpropyl) disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane. The content of the silane coupling agent is preferably 5 to 20 mass % when the total amount of silica is taken as 100 mass %.

The rubber composition according to the present invention contains a diene-based rubber and a fatty acid ester triglyceride (vegetable oil), and preferably further contains silica and a silane coupling agent. The rubber composition according to the present invention may contain, in addition to the above, carbon black, a vulcanizing agent, a vulcanization accelerator, an antiaging agent, stearic acid, a softener such as wax or oil, a processing aid, and others.

The rubber composition according to the present invention may contain carbon black as a filler. Examples of the carbon black that can be used include: carbon blacks usually used in the rubber industry, such as SAF, ISAF, HAF, FEF, and GPF; and conductive carbon blacks such as acetylene black and ketjen black. The content of the carbon black in the rubber composition for pneumatic tires according to the present invention is preferably 1 to 30 parts by mass when the total amount of the diene-based rubber is taken as 100 parts by mass.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition for tires according to the present invention is preferably 0.1 to 10 parts by mass when the total amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading a diene-based rubber and a fatty acid ester triglyceride (vegetable oil), preferably, in addition to silica and a silane coupling agent, carbon black, a vulcanizing agent, a vulcanization accelerator, zinc oxide, an antiaging agent, stearic acid, a softener such as wax, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

The vulcanized rubber of the rubber composition according to the present invention achieves wet grip performance, low-temperature performance, and rolling performance improved in a balanced way. Therefore, the vulcanized rubber of the rubber composition according to the present invention can be suitably used for pneumatic tires, and is particularly useful as a vulcanized rubber used for a surface portion of a tread part called a cap tread in tread applications of pneumatic tires.

### EXAMPLES

Hereinbelow, the present invention will more specifically be described with reference to examples.

### (Preparation of Rubber Compositions for Tires)

A rubber composition for tires of each of Examples 1 to 7 and Comparative Examples 1 to 3 was prepared by blending compounding agents with 100 parts by mass of a rubber component in accordance with a formulation shown in any one of Tables 2 to 3 and kneading the resultant using an ordinary Banbury mixer. The compounding agents shown in Tables 2 to 3 are as follows.

### (Diene-Based Rubber)

Butadiene rubber: trade name “D. NF35”, manufactured by Asahi Kasei Corporation
Terminal-modified butadiene rubber: trade name “Nipol BR1261”, manufactured by Zeon Corporation
Styrene-butadiene rubber: trade name “SBR1502”, manufactured by ENEOS Materials Corporation

### (Vegetable Oil)

Rapeseed oil: trade name “refined rapeseed oil”, manufactured by Nisshin OilliO Co., Ltd.
Soybean oil: trade name “soy salad oil(S)”, manufactured by Nisshin OilliO Co., Ltd.
Palm oil: trade name “refined palm oil(S)”, manufactured by Nisshin OilliO Co., Ltd.
Safflower oil: trade name “safflower oil (high oleic)”, manufactured by Nisshin OilliO Co., Ltd.
Sunflower oil: trade name “sunflower oil(S)”, manufactured by Nisshin OilliO Co., Ltd.

### (Filler)

Carbon black: trade name “N234 Seast 7HM”, manufactured by TOKAI CARBON CO., LTD.
Silica: trade name “Nipsil A”, manufactured by Tosoh Corporation

### (Other Compounding Agents)

Silane coupling agent: trade name “NXT”, manufactured by Momentive Performance Materials Inc.
Oil: trade name “PROCESS NC-140”, manufactured by ENEOS Corporation
Styrene resin: trade name “SYLVATRAXX 4401”, manufactured by Kraton Corporation
Terpene resin: trade name “SYLVATRAXX 4150”, manufactured by Kraton Corporation
Wax: trade name “OZOACE 0355”, manufactured by NIPPON SEIRO CO., LTD.
Stearic acid: trade name “LUNAC S-20”, manufactured by Kao Corporation
Antiaging agent: trade name “NOCRAC 6C”, manufactured by OUCHI SHINKO CHEMICAL INDUSTRIAL CO., LTD.
Zinc oxide: trade name “Zinc oxide grade 2”, manufactured by MITSUI MINING & SMELTING CO., LTD.
Vulcanization accelerator 1: trade name “NOCCELER D”, manufactured by OUCHI SHINKO CHEMICAL INDUSTRIAL CO., LTD.
Vulcanization accelerator 2: trade name “SOXINOL CZ”, manufactured by SUMITOMO CHEMICAL COMPANY, LIMITED
Sulfur: trade name “Powder Sulfur”, manufactured by Tsurumi Chemical Industry Co., ltd.

Unvulcanized samples of the rubber compositions of Examples 1 to 7 and Comparative Examples 1 to 3 obtained above were prepared, and then the wet grip performance, low-temperature performance, and rolling resistance were evaluated under the following conditions.

### (Wet Grip Performance of Vulcanized Rubber)

Four pneumatic tires (tire size: 215/45ZR17) were mounted on a vehicle. Under the condition of an air temperature of 25° C., the vehicle was traveled on a road surface sprinkled with water at a water depth of 2 to 3 mm. The ABS was operated from 90 km/h traveling, and the braking distance during deceleration to 20 km/h was measured (average value of n=10). In the evaluation, the reciprocal of the braking distance was expressed as an index, and expressed as an index when the value in Comparative Example 1 is 100. A larger index indicates that the braking distance is shorter and the wet grip performance is more excellent.

### (Low-Temperature Performance of Vulcanized Rubber)

Storage elastic modulus at −5° C. (E′ (−5° C.)): Using a viscoelasticity measuring device manufactured by GABO, the storage elastic modulus was measured under the conditions of −5° C., a frequency of 10 Hz, a dynamic strain of 0.2%, and a static strain of 10%. The evaluation was expressed as an index when the value in Comparative Example 1 is 100. A smaller index indicates that the elastic modulus at low temperature is smaller, and the low-temperature performance is more excellent.

### (Rolling Resistance of Vulcanized Rubber)

A test pneumatic tire (tire size: 215/45ZR17) was prepared by vulcanization molding using the rubber composition for a tread rubber according to a conventional method. For the obtained test tire, the rolling resistance was measured using a rolling resistance measurement drum tester under the conditions of an air pressure of 230 kPa, a load of 450 kgf (4.4 kN), a temperature of 23° C., and 80 km/h. The evaluation for the reciprocal of the rolling resistance was expressed as an index when the value in Comparative Example 1 is 100. A smaller index indicates that the rolling resistance is smaller, and the low-temperature performance (low fuel consumption performance) is more excellent.

TABLE 2

| Comparative | Comparative | Example | Example | Comparative | Example | Example |
|---|---|---|---|---|---|---|
| Example 1 | Example 2 | 1 | 2 | Example 3 | 3 | 4 |

(Formulation)

| | | | | | | | | |
|---|---|---|---|---|---|---|---|---|
| Diene-based | Butadiene rubber | 50 | | | | | | |
| rubber | Terminal-modified | | 50 | 50 | 50 | 50 | 50 | 50 |
| | butadiene rubber | | | | | | | |
| | Styrene-butadiene | 50 | 50 | 50 | 50 | 50 | 50 | 50 |
| | rubber | | | | | | | |
| Vegetable | Rapeseed oil | 15 | | 15 | | | | |
| oil | Soybean oil | | | | 15 | | | |
| | Palm oil | | | | | 15 | | |
| | Safflower oil | | | | | | 15 | |
| | Sunflower oil | | | | | | | 15 |
| Filler | Carbon black | 10 | 10 | 10 | 10 | 10 | 10 | 10 |
| | Silica | 130 | 130 | 130 | 130 | 130 | 130 | 130 |
| Other | Silane coupling | 11.7 | 11.7 | 11.7 | 11.7 | 11.7 | 11.7 | 11.7 |
| compounding | agent | | | | | | | |
| agents | Oil | 15 | 30 | 15 | 15 | 15 | 15 | 15 |
| | Styrene resin | 20 | 20 | 20 | 20 | 20 | 20 | 20 |
| | Terpene resin | 20 | 20 | 20 | 20 | 20 | 20 | 20 |
| | Wax | 2.2 | 2.2 | 2.2 | 2.2 | 2.2 | 2.2 | 2.2 |
| | Stearic acid | 2 | 2 | 2 | 2 | 2 | 2 | 2 |
| | Antiaging agent | 2.5 | 2.5 | 2.5 | 2.5 | 2.5 | 2.5 | 2.5 |
| | Zinc oxide | 2 | 2 | 2 | 2 | 2 | 2 | 2 |
| | Vulcanization | 2.9 | 2.9 | 2.9 | 2.9 | 2.9 | 2.9 | 2.9 |
| | accelerator 1 | | | | | | | |
| | Vulcanization | 2.1 | 2.1 | 2.1 | 2.1 | 2.1 | 2.1 | 2.1 |
| | accelerator 2 | | | | | | | |
| | Sulfur | 2.1 | 2.1 | 2.1 | 2.1 | 2.1 | 2.1 | 2.1 |

(Evaluation)

| | | | | | | | | |
|---|---|---|---|---|---|---|---|---|
| Vulcanized | Wet grip performance | 100 | 107 | 100 | 100 | 101 | 101 | 102 |
| rubber | Low-temperature | 100 | 141 | 78 | 88 | 109 | 92 | 89 |
| | performance | | | | | | | |
| | Rolling resistance | 100 | 97 | 92 | 93 | 93 | 98 | 100 |

Rapeseed oil has a ratio of the unsaturated fatty acid in the fatty acid of 91.8 mass % and a ratio of the polyunsaturated fatty acid in the unsaturated fatty acid of as high as 30.8 mass %. Also, soybean oil has a ratio of the unsaturated fatty acid in the fatty acid of 84.2 mass % and a ratio of the polyunsaturated fatty acid in the unsaturated fatty acid of as high as 72.3 mass %. As can be seen from the results shown in Table 2, in the vulcanized rubber of the rubber composition according to Example 1 using rapeseed oil and the vulcanized rubber of the rubber composition according to Example 2 using soybean oil, the wet grip performance, low-temperature performance, and rolling performance are improved in a particularly balanced way. Also, it can be seen that also in the vulcanized rubber of the rubber composition according to Example 3 using safflower oil and the vulcanized rubber of the rubber composition according to Example 4 using sunflower oil, the wet grip performance, low-temperature performance, and rolling performance are improved in a balanced way. However, since safflower oil and sunflower oil both have a low ratio of the polyunsaturated fatty acid in the unsaturated fatty acid, it can be seen that safflower oil and sunflower oil are less effective than rapeseed oil and soybean oil. On the other hand, it can be seen that the vulcanized rubber of the rubber composition according to Comparative Example 3 using palm oil having a ratio of the unsaturated fatty acid in the fatty acid of as low as 49.8 mass % is particularly deteriorated in low-temperature performance.

TABLE 3

| | | | |
|---|---|---|---|
| Comparative | | | |
| Example 1 | Example 5 | Example 6 | Example 7 |

(Formulation)

| | | | | | |
|---|---|---|---|---|---|
| Diene-based | Butadiene rubber | 50 | | | |
| rubber | Terminal-modified butadiene | | 50 | 20 | 80 |
| | rubber | | | | |
| | Styrene-butadiene rubber | 50 | 50 | 80 | 20 |
| Vegetable | Rapeseed oil | 15 | 25 | 30 | 5 |
| oil | Soybean oil | | | | |
| | Palm oil | | | | |
| | Safflower oil | | | | |
| | Sunflower oil | | | | |
| Filler | Carbon black | 10 | 10 | 10 | 10 |
| | Silica | 130 | 130 | 130 | 130 |
| Other | Silane coupling agent | 11.7 | 11.7 | 11.7 | 11.7 |
| compounding | Oil | 15 | 5 | 0 | 25 |
| agents | Styrene resin | 20 | 20 | 20 | 20 |
| | Terpene resin | 20 | 20 | 20 | 20 |
| | Wax | 2.2 | 2.2 | 2.2 | 2.2 |
| | Stearic acid | 2 | 2 | 2 | 2 |
| | Antiaging agent | 2.5 | 2.5 | 2.5 | 2.5 |
| | Zinc oxide | 2 | 2 | 2 | 2 |
| | Vulcanization accelerator 1 | 2.9 | 2.9 | 2.9 | 2.9 |
| | Vulcanization accelerator 2 | 2.1 | 2.1 | 2.1 | 2.1 |
| | Sulfur | 2.1 | 2.1 | 2.1 | 2.1 |

(Evaluation)

| | | | | | |
|---|---|---|---|---|---|
| Vulcanized | Wet grip performance | 100 | 97 | 101 | 98 |
| rubber | Low-temperature performance | 100 | 64 | 91 | 56 |
| | Rolling resistance | 100 | 91 | 99 | 84 |

As can be seen from the results shown in Table 3, also in the vulcanized rubbers of the rubber compositions according to Examples 5 to 7 in which the content of rapeseed oil has been variously changed, the wet grip performance, low-temperature performance, and rolling performance are improved in a balanced way.

What is claimed is:

1. A rubber composition comprising a diene-based rubber and a vegetable oil, wherein
the vegetable oil is a fatty acid ester triglyceride in which a fatty acid containing at least a saturated fatty acid and an unsaturated fatty acid is ester-bonded to glycerol and has a ratio of the unsaturated fatty acid in the fatty acid of 50 mass % or more, and
at least a modified butadiene rubber is contained as the diene-based rubber.

2. The rubber composition according to claim 1, wherein the vegetable oil has a ratio of a polyunsaturated fatty acid in the unsaturated fatty acid of 15 mass % or more.

3. The rubber composition according to claim 1, wherein a content of the vegetable oil is 5 to 30 parts by mass when a total amount of the diene-based rubber is taken as 100 parts by mass.

4. The rubber composition according to claim 1, wherein a content of the modified butadiene rubber is 20 to 80 parts by mass when a total amount of the diene-based rubber is taken as 100 parts by mass.

5. The rubber composition according to claim 1, further comprising silica, wherein a content of the silica is 80 to 180 parts by mass when a total amount of the diene-based rubber is taken as 100 parts by mass.

6. A pneumatic tire comprising a vulcanized rubber of the rubber composition according to claim 1.

7. A pneumatic tire comprising a vulcanized rubber of the rubber composition according to claim 1 at least on a surface of a tread part.
